(19) United States
(12) Patent Application Publication
(10) Pub. No.: US 2008/0027913 A1
(43) Pub. Date: Jan. 31, 2008

(54) System and method of information retrieval engine evaluation using human judgment input

(75) Inventors: Chi-Chao Chang, Santa Clara, CA (US); Jian Chen, Union City, CA (US)

Correspondence Address: GREENBERG TRAURIG, LLP, MET LIFE BUILDING, 200 PARK AVENUE, NEW YORK, NY, 10166, US

(73) Assignee: YAHOO! Inc.

(21) Appl. No.: 11/493,268

(22) Filed: Jul. 25, 2006

(51) Int. Cl. G06F 17/30

(52) U.S. Cl. 707/3

(57) ABSTRACT

An information retrieval engine evaluation system and method is disclosed, which uses judgment input, or feedback, received from one or more individuals, or judges. Judgment input is provided by the one or judges, each of whom review at least one aspect of performance of a software application, and provide judgment input in the form of responses to questions. The judgment input is received and analyzed, and can be used to generate the one or more metrics. The metrics can be examined to evaluate at least one indicator in order to determine performance of the software application.

### BACKGROUND

1. Field

This disclosure relates to computing system performance, and more particularly to a system and method for defining and measuring information retrieval performance using a software application (e.g., a search engine), or portion thereof, using one or more indicators of performance.

2. General Background

In a case that an existing software application is modified, or a new software application is created, it would be beneficial to be able to be able to measure the performance of the application.

One example of such a software application, which has become an invaluable tool to search a document store and retrieve information from the data store, is a search engine. With the advent of computer networks, including the World Wide Web or Internet, which have facilitated and expanded access to such data stores, a search engine has become a tool which is used on an everyday basis.

Typically, a search engine has functionality to search and index available information. A software agent, typically referred to as crawler, can be used to traverse the computer network, to locate and identify data items available via computer network. Typically, the search engine uses one or more indices, each of which associates a data item (e.g., a document) available on the computer network and at least one keyword, which corresponds to contents of the data item. In response to a search request, the search engine searches one or more indices to identify documents based on criteria specified in a search request. The search engine typically ranks the result items identified in the search. For example, the search results can be ordered based on one or more criteria, such as relevance, date, etc.

Modifying a search engine's functionality, including any of the areas discussed above, can impact the search engine's performance, e.g., can result in a change in the content and/or appearance of the search results. It would be beneficial to be able to measure what, if any, impact a modification in a software application, such as a search engine, has on the application's performance. In addition, it would be beneficial to be able to design one or more tests, or experiments, to measure such an impact. Further still, it would be beneficial to be able to measure a user's perception of, and/or user impact with respect to, such a modification.

### SUMMARY

The present disclosure seeks to address these failings and to provide a method and system for measuring information retrieval software application performance.

Embodiments of the present disclosure can be used to evaluate at least one indicator, comprising one or more metrics, to determine a degree to which a change impacts performance of a search engine. One example of an indicator is search result relevance. Other examples of indicators include, without limitation, distance, and coverage. Embodiments of the present disclosure determine one or more metrics which operate on judgment input, or feedback, provided by one or more individuals, or judges. Judgment input is provided by one or judges, each of whom review search results generated by the search engine and provide judgment input in the form of responses to questions posed to the judge concerning the search results. The judgment input is received and analyzed, and can be used to generate the one or more metrics. The metrics can be examined to evaluate at least one indicator, e.g., relevance, in order to determine the degree to which a change impacts performance of the search engine.

In accordance with one or more embodiments, an information retrieval engine evaluation is provided, which comprises identifying a query benchmark comprising a plurality of queries, the queries having corresponding search results, obtaining judgment input from one or more judges, the judgment input corresponding to the set of search results, determining, using the judgment input obtained from the one or more judges, at least one metric corresponding to an indicator of performance, a first value of the at least one metric corresponding to a first information retrieval engine and a second value of the at least one metric corresponding to a second information retrieval engine, and comparing the first and second values of the at least one metric to evaluate the performance indicator so as to evaluate performance of the first information retrieval engine relative to the second information retrieval engine.

In accordance with one or more embodiments, search engine performance measurement using a set of stored queries, results and judgments is provided, which comprises generating a query benchmark from the set of stored queries, the query benchmark includes one or more queries, obtaining query results using the one or more benchmark queries, retrieving one or more stored results associated with the plurality of queries, retrieving a judgment associated with at least one stored result, predicting a judgment associated with one or more of the obtained results based on the at least one stored result, and determining a performance measure using the retrieved and predicted judgments.

### DRAWINGS

The above-mentioned features and objects of the present disclosure will become more apparent with reference to the following description taken in conjunction with the accompanying drawings wherein like reference numerals denote like elements and in which:

FIG. 1 provides a process overview for use with one or more embodiments of the present disclosure.

FIG. 2 provides an example of an architecture overview comprising components for use in performance evaluation in accordance with one or more embodiments of the present disclosure.

FIG. 3 provides an example of a portion of a judgment input user interface for use in accordance with one or more embodiments of the present disclosure.

FIG. 4A provides a Spearman footrule distance example in accordance with one or more embodiments of the present disclosure.

FIG. 4B provides a Kendall Tau distance determination example in accordance with one or more embodiments of the present disclosure.

FIG. 5, which comprises FIGS. 5A to 5D, provides various output generated in accordance with one or more embodiments of the present disclosure.

FIG. 6 provides an example of a database structure of analysis database 210 in accordance with one or more embodiments of the present disclosure.

FIG. 7 provides an example of output from a Rasch utility, configured to operate on a model in accordance with one or more embodiments of the present disclosure.

### DETAILED DESCRIPTION

In general, the present disclosure includes a system and method for defining and measuring performance of a software application (e.g., a search engine), or portion thereof, using one or more indicators of performance.

Certain embodiments of the present disclosure will now be discussed with reference to the aforementioned figures, wherein like reference numerals refer to like components.

Embodiments of the present disclosure can be used to evaluate at least one indicator, comprising one or more metrics, to determine a degree to which a change impacts performance of one or more search engines. One example of an indicator is search result relevance. Other examples of indicators include, without limitation, distance, and coverage. Embodiments of the present disclosure determine one or more metrics which operate on judgment input, or feedback, provided by one or more individuals, or judges. Judgment input is provided by one or judges, each of whom review search results generated by the search engine and provide judgment input in the form of responses to questions posed to the judge concerning the search results.

In accordance with one or more embodiments presently disclosed, a mechanism can be used to predict judgment input as an enhancement, or in an absence of, human judgment input. For example, an artificial intelligence engine can be used to predict judgment input received from human judges. The artificial intelligence engine has knowledge of prior human judgment input so as to determine a manner in which a human judge would likely respond to a given search result, or set of search results. In other words, the artificial intelligence engine can be educated based on prior human judgment input in order to predict human judgment input. An “artificial intelligence judge” educated in this manner can then be used as a substitute for, or in addition to, human judges, and can provide judgment input, in accordance with one or more embodiments of the present disclosure.

In addition, a result for which there is no judgment input (e.g., a result that has not been judged to be either relevant or nonrelevant) can be given a judgment prediction. For example, in accordance with one or more embodiments, a result without corresponding judgment input can be predicted to be relevant, or alternatively can be predicted to be nonrelevant. A prediction can be further refined based on the ranking of the result in a search result set in accordance with one or more embodiments. For example, a result which is one of the highest ranking results in a search request (e.g., in the top five results returned by a search engine) can be predicted to be relevant, wherein a result which is one of the lowest ranking results can be predicted to be nonrelevant, or vice versa.

In accordance with one or more embodiments, judgment input is received and analyzed, and can be used to generate the one or more metrics. The metrics can be examined to evaluate at least one indicator, e.g., relevance, in order to determine the degree to which a change impacts performance of the search engine.

Embodiments of the present disclosure are described with reference to search engine performance testing. However, it should be apparent that disclosed embodiments are not limited to search engines, but are applicable to performance testing of any type of software application, consumer electronic device, computing device, etc., the performance of which can be evaluated using human judgment input.

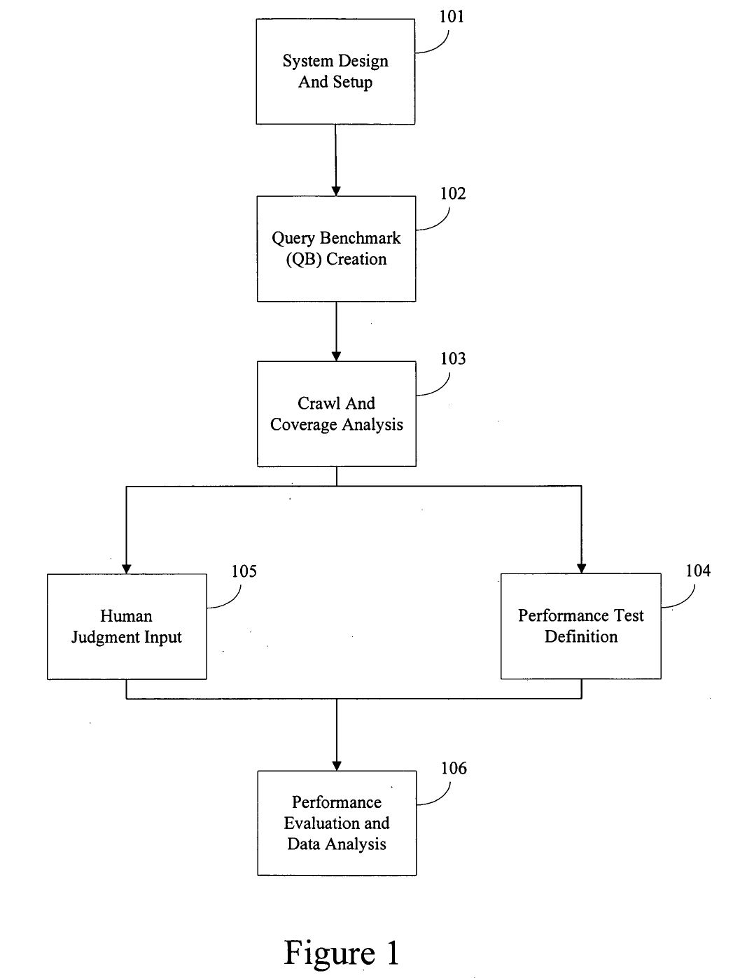

FIG. 1 provides a process overview for use with one or more embodiments of the present disclosure. Step 101 comprises system design and setup, which can comprise identification of a methodology, and general guidelines, for use in evaluating a search engine. For example, system design and setup can be used to define an experimental framework that can be used to evaluate search engine performance, such as establishing guidelines for use in defining a query benchmark, or “QB”, (e.g., number of queries used in a QB, a number of results to be judged for each query in a QB, a criteria for selecting queries, etc.). In a case of selecting queries for a query benchmark, a selection can be automatic, or can be specified by a user, such as a software developer or engineer, or some combination of automatic and manual selection, for example. In a case that queries are selected automatically, any criteria can be used. For example, queries can be selected based on popularity of a query, or lack thereof, such as might be determined based on frequency of use of a query. To illustrate by way of non-limiting example, a set of queries having differing popularity can be selected, such as by selecting a percentage of queries having a high degree of popularity, a percentage of queries having a medium level of popularity, and a percentage of queries having a low degree of popularity. In addition, guidelines can be established for obtaining judgment input from human judges concerning search results (e.g., a number and type of questions to be asked of the judges, the types of responses to each type of question, and the significance of the responses), confidence intervals to be used with the results, optimum combinations of settings of variable, and how the variables affect relevancy and coverage in the optimum region, and what variables are most significant in the optimum region.

In accordance with at least one embodiment, a confidence interval (CI) is an estimated range of values which is likely to include an unknown population parameter. The higher the CI, the more samples (e.g. queries) are needed. A variable (which is also referred to herein as a “knob”) represents a parameter of the search engine which can be used to alter the processing (e.g., retrieval, sorting, result ranking, etc.) performed by the search engine. Examples of parameters, or knobs, include, without limitation, parameters used to weight the information retrieved by a search engine. For example, a title parameter can comprise a predefined value used to weight a search result (e.g., a document) having a corresponding title which contains one or more query terms higher, or lower, than other results having corresponding titles which do not contain a query term. Other examples of parameters include, without limitation, date, popularity, proximity, and literal weighting. A date parameter can be used to boost (e.g., add to) a score or ranking associated with newer documents. A popularity parameter can be used to boost a score, or ranking, of “popular” documents, e.g., a popular document can be determined based on a number of selections or views of the document. A proximity parameter can be used to boost a score, or ranking, associated with a document whose contents include query terms in close proximity to one another. A literal parameter can be used to boost a score, or ranking, of a document which exactly matches a query term. The value of one or more parameters, or knobs, can be changed to “tune” a search engine, so as to find an optimal configuration of the search engine, e.g., so as to identify a configuration in which search engine performance (e.g., relevance of search results generated by the search engine) is the highest. Embodiments of the present disclosure use various metrics (e.g., DCG) described herein to determine search engine performance.

Embodiments of the present disclosure can use parameters in addition to, or as a replacement for, those described above. Examples of other parameters that can be used in accordance with one or more embodiments of the present disclosure include, without limitation, parameters to identify information associated with a document in which to search (e.g., title, anchor text, document body, etc.), parameters which can be used to exclude/include documents based on features of the document (e.g., document layout, appearance, and/or features indicative of spam). In addition, embodiments of the present disclosure can use parameters to use different search indices, or index sizes.

Embodiments of the present disclosure can be used by search engine developers or engineers who develop and/or adjust (or tunes) a search engine, for example. There are many areas of a search engine that can be adjusted, or tuned, which can impact performance, in either a positive or negative way. For example, and as described above, engineers can boost document ranking based on a popularity measure or date associated with a document. Boosts, or weightings, can impact relevance of search results and/or rank, order and/or presentation of search result items, for example. The impact might be a positive or it could be negative. Embodiments of the present disclosure can be used to experiment with design alternatives and then to evaluate the search engine's performance in order to identify an optimal configuration. For example and using one or more embodiments, an engineer, or more generally a user, can study and effect, or effects, of individual and/or combined adjustments to a search engine, and/or interaction(s) that may exist between one or more such adjustments. In addition to different configurations of the same search engine, embodiments of the present disclosure can be used to evaluate performance using more than one search engine. Embodiments of the present disclosure can be used to compare multiple configurations of the same search engine, or multiple configurations of different search engines, for example. It should be apparent that embodiments disclosed herein can be used for a pairwise comparison of two information retrieval engines (e.g., search engines), however, the embodiments are not limited to such a pairwise comparison. Rather, embodiments of the present disclosure can be used to evaluate any number of engines (e.g., different engines or different configurations of one or more engines) using the same or different settings of one or more “knobs”. As is discussed herein, various metrics can be used perform one or more evaluations, even in a case that a complete set of judgment input is unavailable. In a case that incomplete set of judgment input is available (e.g., a cache hit is less than 100%), at least one metric discussed herein can be used to predict relative performance of one or more engines under evaluation.

Step 102 comprises defining QBs and the set of queries to be included in a QB in accordance with system design and setup decisions made in step 101. Step 102 results in one or more sets of queries, each set corresponding to a QB, and each QB comprising one or more queries. In addition, a, sampling period can be established to identify the interval between generation of search results using a given QB. The sampling period can be used to determine when to run a QB to obtain search results. A QB can also include an identification of a type of judgment input to be obtained from a judge, or judges.

The queries specified for a QB are run using one or more search engines to generate query results, at step 103. The queries specified for a QB cab be run by one or more different search engines, and/or different configurations of the same search engine, to generate the output corresponding to each of the search engines, or input a QB to different configurations of the same search engine to generate output for each of the different configuration of the search engine, for example.

In accordance with one or more embodiments of the present disclosure, query results generated by a search engine are analyzed to identify possible duplicate results. In some cases, results can have an identifier. In some cases, the identifier uniquely identifies a result and can provide a mechanism to identify duplicates. In some cases, a document identifier may not necessarily uniquely identify a document. For example, in a case that a result corresponds to a document, e.g., a web page, retrieved from a web site, a universal resource locator (URL) can be used to identify the document. While the same document might be available using multiple different URLs, a document's URL can be used to identify duplicates based on the same or a similar URL, for example. As an alternative, or in addition, to use of an identifier, the contents of a result (e.g., a web page returned by a web search engine) can be examined, and/or metadata associated with result can be examined. In a case that result contents are examined, some portion of the result contents might be ignored (e.g., ad content, certain hypertext tags, etc.).

In addition to storing the query results corresponding to a given QB, information such as the search engine used, the data source/provider searched, temporal information (e.g., date and time of the search), and the number of results generated can be stored for a given QB. Coverage analysis can be performed on the query results generated for a given query. For example, coverage analysis can involve a determination as to the number of results generated for each query for a single run, or aggregated across multiple runs, of the QB, and/or the number of times, and/or frequency with which, the QB is used to generate query results.

Step 105 comprises obtaining, from one or more judges, judgment input corresponding to query results generated from a given QB. Step 104 comprises defining a performance test using a QB. The performance test involves identifying a QB and two “crawls” corresponding to the QB. Each crawl identifies a search engine and a data source/provider. In addition, each crawl has an associated result set corresponding to the set of queries associated with the specified QB. The result set associated with each crawl and judgment input associated with result items in the result sets can be used to evaluate a search engine's performance. For example and using a QB and received judgment input corresponding to the result sets, the specified crawls can be compared based on one or more performance indicators, and one or more metrics associated with the one or more performance indicators, search engine performance can be evaluated, at step 106.

To illustrate by way of a non-limiting example, it is assumed that a performance test is defined, at step 104, which specifies a QB, first crawl associated with a first search engine instance, and a second crawl associated with a second search engine instance. The search engine instances can correspond to different search engines, or can be different configurations of the same search engine, for example. In the example, it is assumed that each crawl has an associated set of results, also referred to as a result set, which comprises one or more result items corresponding to the set of queries, or query set, specified for the QB. In addition, it is assumed that there is some judgment input associated with result items in the result set for both of the crawls. The judgment input was received from at least one judge at step 105.

At step 106, the received judgment input is used to analyze and evaluate performance based on the first and second crawls. To further illustrate using this example, for a given query in the first crawl, there exists judgment input which identifies relevance of a given query result item to a query. The same query is used in the second crawl to generate a subsequent set of search results, which results has one or more search result items in common with the first crawl's set of search results. Since the same query was used, the same relevance judgment input can be used at least with respect to the one or more search result items that appear in both crawls, to determine a relevance of the second crawl's search results to the query.

In addition and in accordance with one or more embodiments, the relevance judgment input corresponding to the first crawl's search results can be used to estimate relevance data for the second crawl's search result items that are absent from the first crawl's search results, and/or to determine an overall relevance score for the second crawl, in step 106. While relevance is used in this example as an indicator of performance, it should be apparent that other indicators can be used to gauge performance, such as distance and coverage indicators, which are discussed herein. In addition, and is discussed herein, it should be apparent that one or more metrics can be determined for a given indicator.

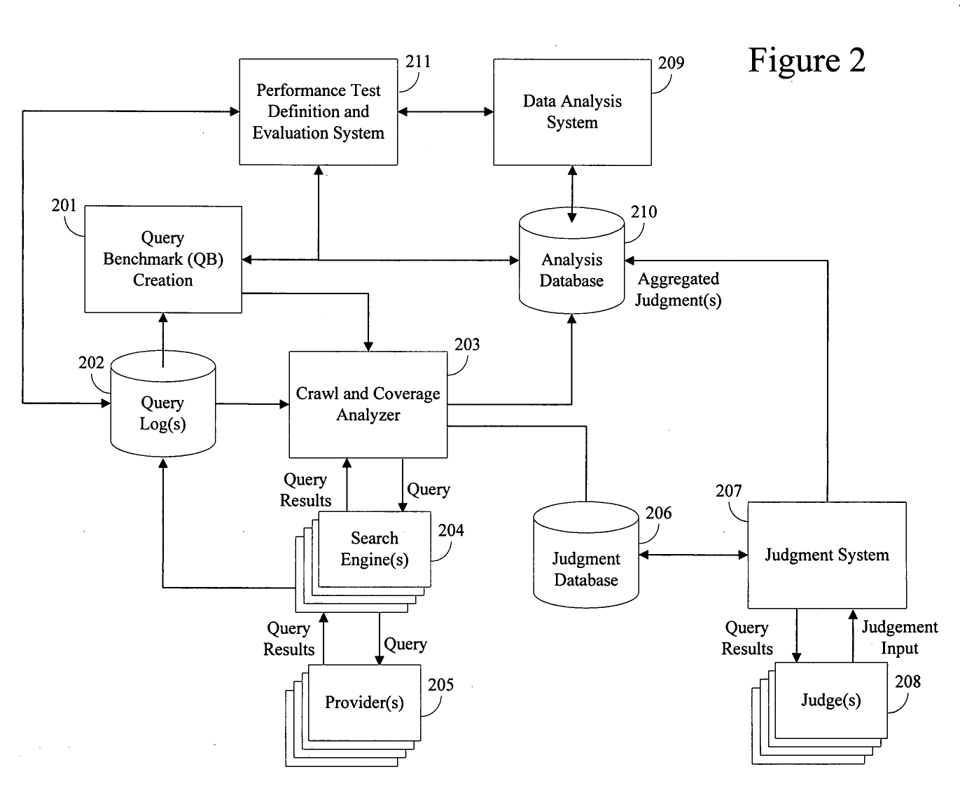

FIG. 2 provides an example of an architecture overview comprising components for use in performance evaluation in accordance with one or more embodiments of the present disclosure. Although not shown, a system design component can be used in accordance with one or more embodiments, which can allow for identification of a methodology, and general guidelines, which methodology and guidelines can be used to configure one or more other components. For example, QB creation 201 can be configured using system design information which identifies the number of queries used in a QB, as discussed herein at least with reference to FIG. 1.

QB creation 201 is configured to define one or more QBs, each of which has an identified query set comprising one or more queries. Crawl and coverage analyzer 203 is configured to request crawls to be performed by search engine(s) 204 of search provider(s)/data source(s) 205, based on the QBs defined by QB creation 201, system configuration information and/or previous crawls identified, for example, using query log(s) 202.

Crawl and coverage analyzer 203 is configured, in accordance with one or more embodiments, to interface with one or more instances of search engine 204, such that a query is forwarded to search engine 204, which queries one or more data providers/sources 205 to retrieve query results and the query results are returned. Crawl and coverage analyzer 203 uses query log(s) 202 to analyze coverage, and to determine whether or not to request one or more subsequent crawls, e.g., based on a sampling period. Coverage analysis performed by crawl and coverage analyzer 203 can include coverage with respect to time, e.g., frequency of occurrence of a crawl, and/or with respect to a number of search results, and/or hits, in a result set, for example.

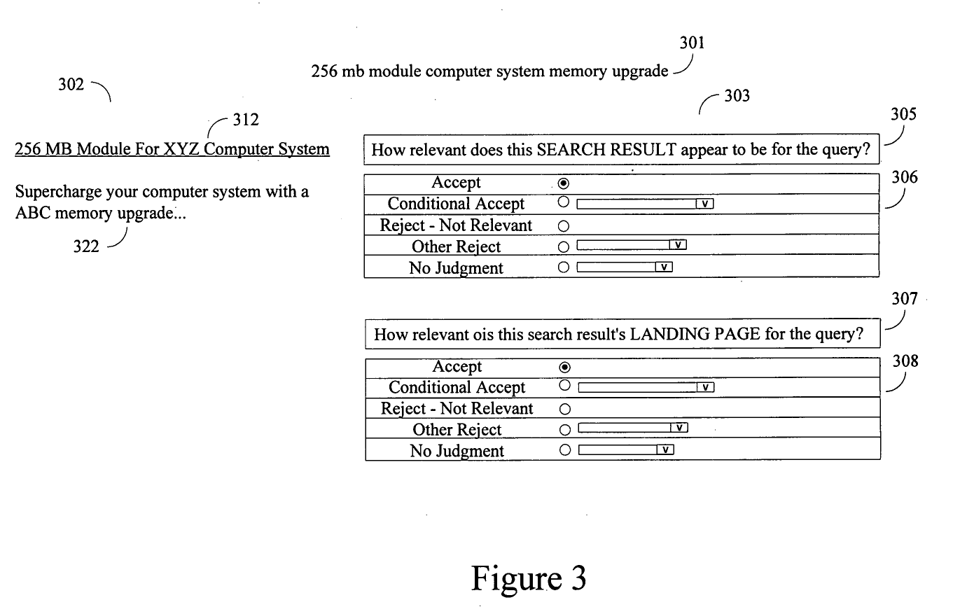

Judgment system 207 is configured to provide query set results to one or more of judges 208 to obtain judgment input, which input can be stored in judgment database 206. FIG. 3 provides an example of a portion of a judgment input user interface for use in accordance with one or more embodiments of the present disclosure. A query 301 is displayed, along with one or more result items 302. Each instance of result item 302 comprises a hyperlink 312, which allows the judge to view a landing page associated with the result item 302, and a text portion 322 of the search result item 302. Although one result item 302 is shown, it should be apparent that there can be multiples instances of result item 302 corresponding to query 301.

In accordance with one or more embodiments, judgment system 207 can assess reliability of judgment input. Some queries and/or results can be ambiguous which may result in inconsistent judgment input from multiple human judges. Judgment system 207 can be used to identify these queries and results, and remedial measures can be taken including removal of a query and/or result from a QB.

Intra-judge agreement is another reliability measure that can be assessed using judgment system 207 in accordance with embodiments of the present disclosure. Judgment 207 can be used, for example, to determine whether or not a judge 208 is giving different relevance judgment input to the same result at different times. Inconsistencies in judgment input provided by a judge 208 can raise a question as to the reliability of the judgment input. In addition, a judge 208 may have a bias that can impact the judgment input for that judge. Such an inconsistency can be detected based on an examination of judgment input across judges and/or examination of inconsistencies in judgments received from a single judge, for example. Judgment system 207 uses statistical techniques to systematically detect inconsistent judges and/or results. In accordance with at least one embodiment, judgment system 207 uses one or more of percent agreement (PA), correlation measure (CM), and many-facets Rasch model (MFRM) testing to detect inconsistent judges and/or inconsistent judgment input. PA and MFRM can be used, in one or more embodiments, to identify judges who are making inconsistent judgments and/or results that received inconsistent judgments. CM can be used, in one or more embodiments, to identify inconsistent judges.

In accordance with one or more embodiments, one or more tests can be used to evaluate inter-judge agreement, or consensus among human judges, and/or intra-judge, or consistency of an individual judge. The PA test, or statistic, can be used to determine a percentage of identical judgments among the judges providing input for a given result. The CM test can be used to determine an average correlation of judge's judgments relative to other judges. The MFRM test can be used to estimate and evaluate differences in judge severity and screen judges whose judgments lack variation or self-consistency. The PA and MFRM tests can be used to identify judges who are making inconsistent judgments and results that have received inconsistent judgment input, for example. CM can be used to identify inconsistent judges.

In accordance with one or more embodiments, a judgment set is constructed for a random set of queries, “Q”. The judgment set is provided by J judges, each judge, j, evaluating a subset of queries in Q, Qⱼ. In accordance with at least one of the embodiments, the query subset, Qⱼ, for each judge, j, is done such that each query, q, has R results and is judged by at least D judges. That is, for a query, q, of a query set Qⱼ, each judge, j, enters R judgments. The judgment, or judgment input, can comprise a value, x, taken from a scale, C, which comprises categories representing values of x. For example, in a case that the judgment input represents relevance using a tertiary (or three-category or value) scale, C, which comprises value categories of “2”, “1” and “0”, a result can be rated as highly relevant (e.g., c-value of “2”), relevant (e.g., c-value of “1”), or nonrelevant (e.g., c-value of “0”). Thus, in the example described, there can be a judgment set consisting of tuples <q, r, j, x> where x is the judgment input value input by judge j for a result r and a query q. The total number of judgments can be determined to be: total judgment input=total number of queries, Q, multiplied by the total number of results, R, multiplied by the total number of judges, D, judging the results.

Embodiments of the present disclosure identify a filter, F_{q}, that returns a set of queries in Q that are determined to be too subjective or difficult to evaluate by the judges, and a filter, Fⱼ, that returns a set of judges in J determined to provide judgment input inconsistent (e.g., judgment input is too lenient, conservative, and/or unreliable) with other judges in J.

In accordance with one or more embodiments, a PA statistic counts raw matching scores for each query result pair, <q, r>, CM determines an average correlation of a judge's judgments with those of other judges, and MFRM compares a severity of all judges on all items, even if they did not rate the same items. The PA can be used to evaluate a degree of agreement of judgments among judges for a particular result. Let k be the total number of categories (1≦k≦C). For each <q, r> pair, or case, m, let nₖₘ be the number of times category k is applied. For example, if <q, r> is rated 5 times and received ratings of 1, 1, 1, 2, 2, then n₁ₘ=3 and n₂ₘ=2. Let nₘ be the total number of ratings made on case m, for the <q, r > pair:

$${n}_{m} = {\sum }_{k = 1}^{C} {n}_{k m} \qquad ( 1 )$$

For each case m, or for each <q, r> pair, the number of agreements on rating level k is nₖₘ×(nₖₘ−1). Using the above ratings example, the agreement on rating k=1 is 3×2=6, and the agreement on rating k=2 is 2×1=2. The number of agreements across all categories is:

$$SP = {\sum }_{k = 1}^{C} {n}_{k m} \times ( {n}_{k m} - 1 ) \qquad ( 2 )$$

The total possible number of agreement on case <q, r> is:

SAP=M×(M−1), (3)

where 1≦M≦J. The percent agreement for case m. for a given <q, r> pair, is defined as:

$${PA}_{m} = \frac{SP}{SAP} , \qquad ( 4 )$$

where 1≦m≦Q×R. Using the same example as above, the percent agreement is:

$$\frac{3 \times 2 + 2 \times 1}{5 \times 4} = 0.4 \qquad ( 5 )$$

The filter, F_{q}, which can be used to filter queries that received inconsistent judgments, can be defined as:

$${F}_{q} = \{ \begin{matrix}1 & ⋯ & if {PA}_{m} \leq 0.5 ; \\ 0 & ⋯ & Otherwise\end{matrix} \qquad ( 6 )$$

To filter judges based on determined inconsistent judgments, a set of <q, r> for which the percent agreement is high (PAₘ>0.5) is determined. This set of cases can be and the corresponding judgments can be referred to as “golden” sets. A percentage of matches can be computed between each judge's judgments for the <q, r> and the golden sets. Let M be the total number of cases in the golden set, and A be the number of matches, a judge's agreement statistic with the “golden” set can be defined as:

$${JA}_{j} = \frac{A}{M} , \qquad ( 7 )$$

where 1≦j≦J. The filter Fj for inconsistent judges can be defined as:

$${F}_{j} = \{ \begin{matrix}1 & ⋯ & if {JA}_{j} \leq 0.5 ; \\ 0 & ⋯ & Otherwise\end{matrix} \qquad ( 8 )$$

In accordance with one or more embodiments, a correlation measure comprises an average correlation of a judge's judgments with those of every other judge. High values of correlation between two judges indicate a similarity of their judgments. Judges who are known to be reliable can be identified as “golden judges”. High correlation values between a judge and a golden judge can be used to identify a reliable judge and results.

The CM uses correlations among judges to identify inconsistency. In accordance with at least one embodiment, each judge judges every case. In such a case, the total number of judgments is Q×R×J. The CM correlates two judges, x and y, at a time, with Q×R judgments from each judge, the judgments being referred to as xᵢ and yᵢ, where 1≦i≦Q×R. In accordance with one or more embodiments, a standard Pearson's correlation can be used to determine a correlation between the two judges using the following, for example:

$${r}_{xy} = \frac{{\sum }_{i = 1}^{Q \times R} ( {x}_{i} - \overline{x} ) \times ( {y}_{i} - \overline{y} )}{( n - 1 ) \times {s}_{x} \times {s}_{y}} , \qquad ( 9 )$$

where sₓ and s_{y} are the standard deviation of x and y. The total number of inter-judge correlation can be determine as follows:

$$N = \frac{J \times ( J - 1 )}{2} \qquad ( 10 )$$

A sum of all of the inter-judge correlation can be determined as follows:

$${r}_{total} = {\sum }_{i = 1}^{J} {\sum }_{j = i}^{J} {r}_{ij} \qquad ( 11 )$$

An average inter-judge correlation can be determined as follows:

$$\overline{r} = \frac{{r}_{total}}{N} \qquad ( 12 )$$

A variance of inter-judge correlation can be determined as follows:

$$var ( r ) = \frac{{\sum }_{i = 1}^{N} {( {r}_{i} - \overline{r} )}^{2}}{N} \qquad ( 13 )$$

A standard deviation can be determined as follows:

σᵣ=\sqrt{var(r)} (14)

An average correlation for judge j can be determined as follows:

$${r}_{j} = \frac{{\sum }_{i = 1}^{j} {r}_{i} - 1}{J} \qquad ( 15 )$$

A filter for inconsistent judges can be defined as follows:

$${F}_{j} = \{ \begin{matrix}1 & ⋯ & if {r}_{j} ≺ \overline{r} - 2 \times {σ}_{r} or {r}_{j} ≻ \overline{r} + 2 \times {σ}_{r} ; \\ 0 & ⋯ & Otherwise\end{matrix} \qquad ( 16 )$$

In accordance with one or more embodiments, a Many Facets Rasch Model (MFRM) can be used to estimate differences in judge severity and screen judges whose judgments lack variation or self-consistency. The MFRM can be used to provide estimates of the consistency of observed rating patterns. Fit can be used as a quantitative measure of the discrepancy between the statistical model and the observed data. An expectation is that highly relevant results achieve consistently higher scores than less relevant results, and a residual difference between expected and observed scores is the basis of fit analysis. Two fit statistics can be reported: an infit score and an outfit score.

The MFRM test can use one or more “facets” in evaluating a judge and/or judgment input. Examples of facets that can be used in one or more embodiments include, without limitation, inherent relevancy of a search result for a given query, difficulty of the questions asked, severity of a judge, and difficulty of rating scale. The MFRM is based upon the assumption that one should use all of the information available from all judges (including discrepant ratings) when attempting to create a summary score for each search result being judged. It is not necessary for two judges to come to a consensus on how to apply a scoring rubric because differences in judge severity can be estimated and accounted for in the creation of each result's final score. When a search result is rated by a judge, the log odds (logit) of it being rated in category x is modeled by the following:

$$log ( \frac{{P}_{njk}}{{P}_{nj ( k - 1 )}} ) = {ϑ}_{n} - {β}_{j} - {ξ}_{k} , \qquad ( 17 )$$

where Pₙⱼₖ is a probability of search result n being awarded a rating of k when rated by judge j, Pₙⱼ₍ₖ₋₁₎ is a probability of result n being awarded a rating of k-1 when rated by judge j, θₙ is a relevancy of search result n, βⱼ is a severity of judge j, and ξₖ is a difficulty of achieving a score within a particular score category k.

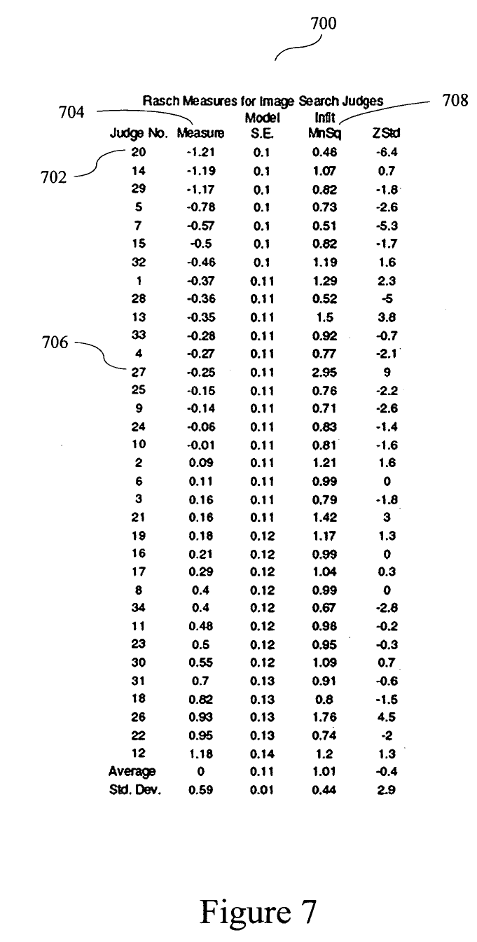

In accordance with one or more embodiments of the present disclosure, a model such as that set forth in expression (17) is used to configure a Rasch measurement software utility, such as that provided by Winsteps®, which operates on the judgment input using the model to generate measures such at those shown in FIG. 7.

The example output shown in FIG. 7 reflects from raw input received from thirty-four judges, each of whom provided relevancy input for the top five results of thirty queries generated from a search engine. The results were randomly mixed and shown to the judges. Each judge was asked to provide judgment input as to the relevancy of each search result for each query based on a five point scale: 1) excellent, 2) good, 3) fair, 4) bad, and 5) no judgment. The results were recorded and were input to the Rasch software utility, which operated on the raw input using the above-identified model.

The measure column 704 lists normalized logit values for severity of judges. The maximum value in column 704 identifies the most lenient judge. The minimum value in column 704 identifies the most severe judge. In this case, row 702 corresponds to the judge (i.e., judge number 20) who gave the most lenient scores, and row 706 corresponds to the judge (i.e., judge number “12”) who gave the most severe score.

The inventors have determined that a judge's severity measure is highly correlated with the difference of the judge's average score and the overall average score. The “Infit MnSq” column 708 provides a consistency measure for each of the judges. For all the judges, the mean value of “Infit” is 1.01 with a standard deviation of 0.44. As one example of a guideline, if the “Infit” value goes outside of the value of Mean±2×Std.Dev., the judge is considered to not be applying the scoring criteria consistently. In the example shown in FIG. 7, the accepted range of“Infit” values is 1.01±2×0.44, or [0.13, 1.89]. Using the example guideline, row 707 (i.e., judge number 27) is identified as a “misfit”. The inventors determined that this judge's scores for each result significantly deviated from the average score of each result determined across all of the judges, sometimes by as much as 127%.

In accordance with one or more embodiments, an Infit mean square is an information-weighted chi-square statistic divided by its modeled degrees of freedom. An example of an equation for determining an Infit mean square for a given judge, j, is as follows:

$${V}_{j} = \frac{{\sum }_{n = 1}^{N} {\sum }_{j = 1}^{J} {( {x}_{nj} - E ( {x}_{nj} ) )}^{2}}{{\sum }_{n = 1}^{N} {\sum }_{j = 1}^{J} var ( {x}_{nj} )} , \qquad ( 18 )$$

where var(xₙⱼ) can be determined as follows:

$$var ( {x}_{nj} ) = {\sum }_{0}^{m} x - E ( {x}_{nj} ) ) p ( {x}_{nj} ) , \qquad ( 19 )$$

where, under the Rasch model conditions, var(xₙⱼ), which comprises a modeled variance of an observation around its expectation. In equation (19), var(xₙⱼ) is the variance of the observation awarded to result n by judge j, m is the highest numbered category for observations, p(xₙⱼ) is the expected value of the observation, E(xₙⱼ) is the probability that result n will be observed by judge j in category x.

An Infit scoring can be used to compare the sum of squared ratings residuals with their expectation. In accordance with one or more embodiments, a range of the Outfit and In-fit scoring is 0 to infinity, with a modeled expectation of 1.00 and a variance inversely proportional to the number of independent replications in the statistic referenced. The Infit scoring is sensitive to an accumulation of on-target deviations that are less or more consistent than expected. The Outfit scoring is sensitive to off-target responses due to carelessness or misunderstanding. In one or more embodiments, the Infit scoring is used rather than the outfit scoring. In accordance with disclosed embodiments, an outfit mean-square can be a chi-square statistic divided by its degrees of freedom, as follows:

$${U}_{j} = {\sum }_{n = 1}^{N} {\sum }_{j = 1}^{J} \frac{{( {x}_{nj} - E ( {x}_{nj} ) )}^{2} / var ( {x}_{nj} )}{NJ} , \qquad ( 20 )$$

where N is the number of search results and J is the number of judges.

Referring again to FIG. 3, a judgment input 303 portion includes one or more questions and associated response options. -In the example shown in FIG. 3, judgment input 303 comprises “per item” judgment input, whereby a judge is asked to provide judgment input for each result item in a result set for a given query. For example, question 305 prompts a judge to provide a response, in response portion 306, concerning relevance of result item 302 to query 301. The judge has an option of accepting the result 302 as relevant, conditionally relevant, rejected as not relevant, rejected for another reason, or no judgment offered. An instance of pull-down menu 310 allows a judge to make a selection to further refine a response. The contents of a pull-down menu 310 can be specific to a given question and response, for example.

In the example shown in FIG. 3, the judge is asked to also indicate a relevance of the landing page to the query in question 307. The judge can view the landing page by selecting hyperlink 312. As with question 305, the judge has an option of accepting the result 302 as relevant, conditionally relevant, rejected as not relevant, rejected for another reason, or no judgment offered, in response portion 308. Pull-down menu(s) 310 allows a judge to further refine a response. As indicated above, the contents of a pull-down menu 310 can be specific to a given question and response.

In accordance with one or more embodiments, result items can be scrambled and displayed in a generic way, so as to reduce a possibility of bias toward a particular search engine, for example. Examples of other types of judgment input include, without limitation, “per set” and “side-by-side”. With regard to “per set” judgment input, a judge provides judgment input on a result set basis. For example, a judge can be asked to provide judgment input for a result set based on a first page of results. A judge can take into account features such ranking of results in the result set and/or provider/source diversity associated with a result set, etc. With regard to side-by-side judgment input, a judge is requested to review two sets of search results side-by-side, e.g., the top 10 results), and provide judgment input as to which side the judge prefer. The judge can also be asked to provide an explanation/reason for the preference. To minimize bias, the result sets can be presented in a manner so as to minimize a judge's ability to identify a search engine by its output.

Referring again to FIG. 2, judgment system 207 can store judgment input in judgment database 206, and/or aggregate judgment input and forward the aggregated judgment input to analysis database 210. Judgment input can be aggregated across performance tests, and can include recent score, average score, maximum score and minimum score, for example. Multiple judgment input for a query result can be due to judgment input from more than one judge, or the same result item being judged across various performance tests, for example. In addition, judgment system 207 can forward non-aggregated judgment input to analysis database 210. In fact and although the databases are shown separately in FIG. 2, it should be apparent that analysis database and judgment database 206 can comprise the same database.

Analysis Database 210 comprises data used by data analysis system 209 to generate one or more metrics corresponding to indicators output via performance test definition and evaluation system 211 to a user. Performance test definition and evaluation system 211 provides a user interface that allows a user to select an existing QB, first crawl and second crawl, or to request/define a new QB, a new first crawl and/or a new second crawl, so as to define a performance test. In accordance with one or more embodiments, the QB selection filters the crawl selection available to the user, to crawls associated with the QB. A QB comprises a set of queries, each of which can be entered by the user or selected from query log(s) 202. Each QB has a name, and can have other information such as creation date, etc. In addition, the first and second crawl specified for a performance test comprises a result set for each query in a query set corresponding to the selected QB.

In addition and in defining a performance test, a user can identify one or more indicators, and one or more metrics for a given indicator, of performance for use with the performance test. Examples of indicators/categories of metrics include distance, relevance and coverage.

Distance metrics provide an overview of the degree to which result sets associated with the two crawls vary. For example and with regard to a specific query and the result sets for the query in the two crawls, a metric can provide a measure of a degree to which the ordering of the results vary in the two result sets, or measure of a degree to which the two results contain different result items, etc. Examples of distance metrics include, without limitation, Spearman footrule, Kendall Tau, and set overlap metrics.

A Spearman Footrule metric comprises a sum, across n result items in a first result set R1, of the absolute difference between the rank of the ith result item in result set R1 and the rank of the same result item in a second result set, R2. A normalized footrule distance can be determined by dividing the sum by a normalization value. An example of a normalization value which can be used in one or more embodiments is a square of a maximum shift value, S, divided by two, or (|S|* |S|)/2. A normalized footrule distance can range from zero and one, where a zero value indicates that, in the two results sets, the result items are ranked the same, and a value of one indicates that the results are either ranked in reverse order or the results in the two result sets are different. The normalized footrule distance can be used to identify a difference between the result sets R1 and R2 that might lead to further examination of one or more queries and corresponding results sets in one or both of the crawls, for example. Assuming, for example, that result set R1 was provided using a search engine 204 instance prior to a change and that result set R2 was provided using a search engine 204 after a change to the search engine instance. A high normalized footrule distance value can indicate that the change had a significant impact on performance of the search engine 204 instance, and further examination is warranted to determine whether or not the change in performance is preferred.

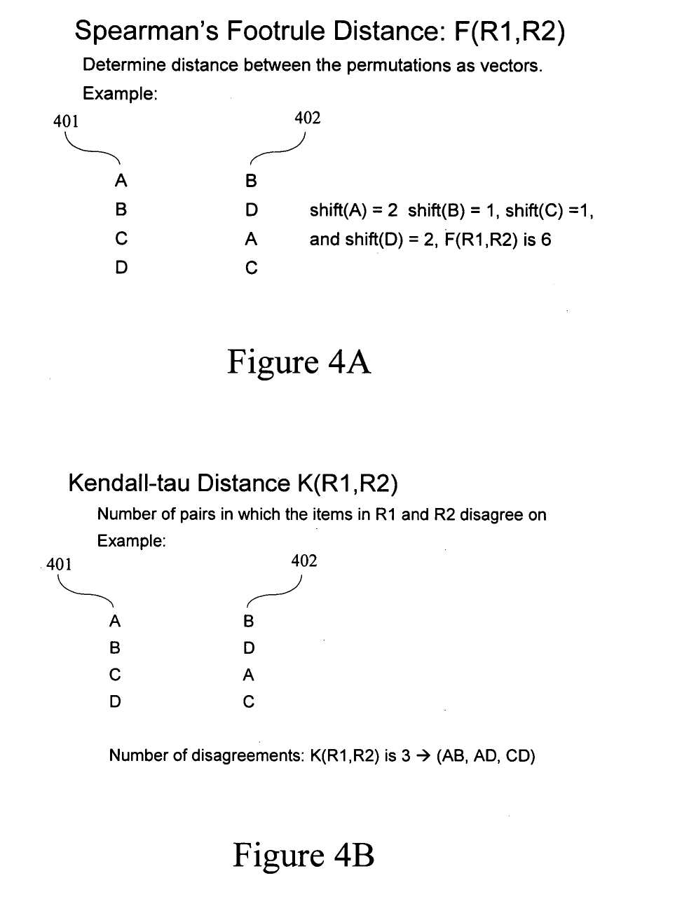

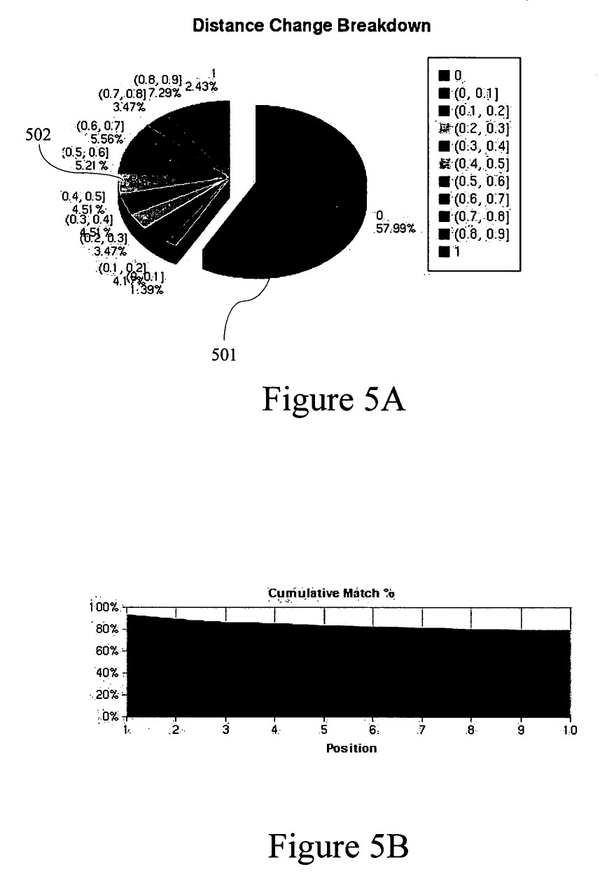

FIG. 4A provides a Spearman footrule distance example in accordance with one or more embodiments of the present disclosure. In the example shown, R1 corresponds to list 401 and R2 corresponds to list 402. With regard to the first item, A, in list 401, it can be seen that item, A is shifted from first position in list 401 to third position in list 402. It can be said that the absolute difference, or shift, of item A as between lists 401 and 402 is 2. In addition, the differences, or shifts, relative to items B, C and D can be said to be 1, 1 and 2. The sum of the distances is 6, i.e., 2+1+1+2. A normalization value can be (4*4)12, or 8, since a maximum shift value, S, can be four. A normalized value using the normalization value of 8 is 6/8, or 0.75.

In accordance with one or more embodiments, a Kendall Tau metric used in connection with a distance indicator comprises a count of the number of pair-wise disagreements between two lists, R1 and R2, which can be expressed as follows:

K(R1, R2)=|{(i, j)|i<j, R1(i)<R1(j), but R2(j) >R2(j)}|, (21)

where i and j are positions in R1 and R2. A non-zero distance for a given pair of items is indicated where a position of one result item, i, in R1, or R1(i), is less than a position of another result item,j, in R1, or R1(j), but in R2, the position result item, i, or R2(i) is greater than the position of result item,j, in R2.

FIG. 4B provides a Kendall Tau distance determination example in accordance with one or more embodiments of the present disclosure. In the example, which uses the same lists-as in FIG. 4A, R1 corresponds to list 401 and R2 corresponds to list 402. With regard to the first item, A, from list 401, it can be seen that the position of item A, i.e., in the first position, is less than the position of item B, i.e., in the second position, in list R1. In list 402, however, A's position, i.e., in the third position, is greater than B's position, in the first position. The AB pair is considered to be a pair whose items disagree in lists 401 and 402. As indicated in FIG. 4B, there are two other pairs, i.e., AD and CD, that disagree. The Kendall Tau distance, or K(R1,R2) for the example shown in FIG. 4B is therefore 3. A normalization Kendall Tau distance can be determined by dividing K(R1,R2) by a maximum possible value, e.g., (|S|/2), e.g., 6/2, or 3.

A further discussion of Spearman footrule and Kendall Tau distance metrics can be found in an article entitled, Rank Aggregation Methods For The Web, by Cynthia Dwork, Ravi Kumar, Moni Naor, and D. Sivakumar, In proceeding of the Tenth International World Wide Web Conference, 2001, and in an article entitled Comparing Top k lists, by R. Fagin, R. Kumar, and D. Sivakumar, In proceedings of the ACM-SIAM Symposium on Discrete Algorithms, 2003, both of which re incorporated herein by reference.

Set overlap is the number of overlapping pairs between two result sets. Assuming a set of two lists, set overlap compares a pair of items identified as the items at a given level (e.g., row) in the two lists. The result is the number of item pairs taken from the two lists that are the same. For example, if the first set is {x, with N or more elements} and the second set is {y(i), with N or more elements}, overlap is defined as the number of common elements in {x(i), 1≦i≦N} and {y(i), 1≦i≦N} (i.e., where x(i) and y(i) match) divided by N. The comparison of the lists can involve all of the items in the lists, or some number up to a certain level. For example, in a case that N equals 100, set overlap can be performed on all 100 items, or the first M items.

In accordance with one or more embodiments of the present disclosure, a relevance indicator comprises a measure of a precision corresponding to one or more result sets. Precision can correspond to a determination of a number of the results in a result set are relevant to a given query, or topic, for example. Recall can correspond to a determination ratio of a number of relevant results returned to the number of results returned for a given query, or topic, for example.

A precision metric can be computed for a given query and can comprise a mean average precision metric, and a discounted cumulative gain, for example. A precision metric, referred to as a rank-based precision metric, can be determined based on result item rank. For example, result items in a result set can be ranked from 1 to n (where n can be the total number of result items, or some number less than the total number of result items). The ranking can be based on a relevance score determined using judgment input, for example. A result item can be considered to be the most relevant to a query, and the next result item is the second-most relevant to a query, etc. A parameter associated with a rank-based precision metric can identify a threshold position (or rank) from 1 to n, which represents a position in the ranking of the result items, such that result items at and above the threshold are used in determining the rank-based precision metric, for example. For example, in a case that n is equal to 20 and the threshold is 5, result items 1 to 5 are used to determine a precision metric value, and result items 6 to 20 are excluded from the determination.

In accordance with one or more embodiments of the present disclosure, a precision metric can be an aggregate. For example, query-level (rank-based or otherwise) precision metrics corresponding to queries in a given crawl can be aggregated to yield a crawl-level (rank-based or otherwise) precision metric. As with a query-level rank-based precision metric, a rank-based precision metric corresponding to a given crawl can represent a relevance score for result items up to a threshold position.

Another example of an aggregate precision metric at the crawl-level is an average of relevance scores for all result sets corresponding to the queries in a crawl's query set. In a case that a relevance score for a given result item is indicated as a 0, if irrelevant, and 1, if relevant, an averaged precision metric can be the average of relevance scores (rank-based or otherwise) in a result set, such averaged precision metric can range from 0 to 1, where 0 indicates that there are no relevant results, and 1 indicates that all of the result items are relevant. In accordance with one or more embodiments, an averaged precision metric is also referred to as a precision level, which precision level can be determined for each of the crawls in a performance test.

In accordance with one or more embodiments, a discounted cumulative gain (DCG) precision metric can be used as a relevance indicator corresponding to the first and second crawls. In determining a DCG precision metric value, precision (e.g., a relevance score) at each position is used as a “gain” value measure for its ranked position in the result and is summed progressively from position 1 to n. A discounting function progressively reduces the document score as the rank keeps increasing but not steeply (e.g., division by the log of the rank). The cumulated gain vector is defined recursively as

$$DCG [ i ] = \{ \begin{matrix}G [ 1 ] , & if i = 1 ; else \\ DCG [ i - 1 ] + G [ i ] / log ( i + 1 ) , & if i > 1\end{matrix} , \qquad ( 22 )$$

where i is a rank position and G[i] is a scale value at position i.

An idealized DCG value can be computed by reordering the results, with the relevant results ranked above the irrelevant results, and an idealized DCG (IDCG) value can be computed as above. In addition, a normalization of an idealized DCG can be determined. For example, let <v1, v2, . . . vk> represent the DCG vector and <i1, i2, . . . , ik> represent the idealized DCG vector, then the normalized DCG is given by <v1/i1, v2/i2, . . . vk/ik>. By averaging over all of the result sets for a given crawl, a DCG precision metric can be determined for the crawl, such that the performance of one crawl can be compared to another. The average vectors can be visualized as gain by rank graphs. A further discussion of cumulative gain can be found in an article entitled Cumulated Gain-Based Indicators Of IR Performance, by Kalervo Jarvelin, Jaana Kekalaninen, In proceedings of the ACM Transactions on Information systems, 2002, the contents of which are incorporated herein by reference.

In accordance with one or more disclosed embodiments, the DCG is used in a case that there is no prior knowledge of relevance in connection with a given one or more search engines. Alternatively and in a case that there is prior knowledge that relevance of the search engines is relatively good, the LinearFT metric can be used as it is likely to be more robust than the DCG metric in terms of preserving system ranking and accuracy based on significance tests under incomplete judgments

The DCG preserves system ranking and has the best accuracy based on significance tests under various levels of incomplete judgments. A system ranking can be defined as an ordered list of search engines sorted by decreasing evaluation measure score. Significant tests are based on hypothesis testing. For a pair of search engines, the null hypothesis (H0) is that the relevance metrics are equal for both engines. If confidence in the hypothesis (reported as a p-value) is ≦0.05 (at 95% confidence level), the null hypothesis is typically rejected, i.e., the two engines have statistically significant difference based on the relevance metric. To test the hypothesis, the value of the DCG metric for each query is calculated. For each search engine, there is a vector of metric values for all the queries. The two vectors of metric values from the two engines can be compared using a pairwise Wilcoxon test to determine the p-value.

The Discounted Cumulative Gains (DCG) metric is defined as described above. For example, if the scale value for a relevant document is 1, and the scale value for a nonrelevant document is 0, the DCG metric is the following:

$$Binary DCG [ i ] = {\sum }_{r} \frac{1}{log ( i + 1 )} , \qquad ( 23 )$$

where r is a relevant document, and i is the rank position of the relevant document. In essence, it is the summation of the inverse log rank for all relevant documents. The binary scale DCG metric is more robust under incomplete judgments compared to the DCG metric with more than two scale values.

The binary DGC uses a binary relevance scale, by which a document, x, has a designated relevance score of 0 or 1, e.g., a document, x, has a relevance scoring of rel(x)=1 if it is relevant, and a scoring of rel(x)=0 if it is not relevant. An example of a tertiary scale which uses a three category scoring scale, by which in a case that document, x, is highly relevant its corresponding scoring is rel(x)=2, rel(x)=1 in a case that it is relevant, and rel(x)=0 in a case that it is not relevant. The inventors determined that there is no significant difference between the binary and tertiary DCG values.

In accordance with at least one disclosed embodiment, binary judgments assume rel(x) ∈{0, 1} such that rel(x)=0 denotes x is not relevant to the topic and rel(x)=1 denotes x is relevant to the topic. In a case of a scaled judgment (e.g., a five point scale: 1) excellent, 2) good, 3) fair, 4) bad, and 5) no judgment), the value of rel(x)>0 to indicate the degree of relevance. In a case of incomplete judgments, there is at least one x in which the rel(x) is unknown, e.g., x has not been judged for a given query, or topic.

If there is prior knowledge that relevance of the search engines is relatively good, the LinearFT metric is likely to be more robust than the DCG metric in terms of preserving system ranking and accuracy based on significance tests under incomplete judgments. The LinearFT metric can be determined as follows:

$$LinearFT = {\sum }_{r} \frac{1}{log ( i + 1 )} - {\sum }_{nr} \frac{1}{log ( i + 1 )} , \qquad ( 24 )$$

where r is a relevant document, nr is a nonrelevant document, and i is the rank position of the document. In essence, it is the difference between the summation of inverse log rank for all relevant documents and all nonrelevant documents.

In the above example, the difference between the DCG metric and the LinearFT metric is the treatment of nonrelevant documents. In the DCG metric, the nonrelevant documents are ignored. However, in the LinearFT metric, there is a penalty for known nonrelevant documents. When relevance of the search engines is already good, the penalty for known nonrelevant documents provides additional differentiating power. On the other hand, when relevance is low for the search engines, the LinearFT metric may be dominated by the penalty for known nonrelevant documents and becomes noisy.

Another example of an indicator which can be used in one or more embodiments is a coverage indicator, which can have one or more associated metrics that can be used as an estimate of an availability of results for a given query. Examples of coverage metrics include, without limitation, a “number of results”, a “number of hits”, and a “cache hit”. In accordance with one or more embodiments, a “coverage” parameter can be established, which represents a maximum number of result items in a result set. However, it is possible that a result set has fewer than the threshold maximum number of result items. The “number of hits” for a given result set represents the actual number of result items in the result set. The “number of results” can be expressed as a ratio of the “number of hits” to the threshold maximum number of result items. The “cache hit”, or “cache percentage”, comprises a percentage of the number of result items in a result set for a given crawl which have corresponding judgment input. On an aggregate level, the coverage metrics can be the average number of results over all queries for both crawls.

Examples of coverage metrics include, without limitation: 1) a percentage of queries in the QB with at least one result, 2) an average number of results per query in the QB, 3) a median number of results per query in the QB. A histogram can be used to show the absolute number of judgments for both the crawls at each position. Another metric can represent the number of empty queries( no results) for each crawl. If the cache hit ratio/percentage is 100%, judgment input is available for every result item. The relevance indicator, and performance estimation, can be considered to be highly accurate. If the cache hit ratio/percentage is less than 100%, performance estimation is likely less accurate. Embodiments of the present disclosure provide functionality for use in estimating performance in either case.

Performance test definition and evaluation system 211 can facilitate performance evaluation based on judgment input and using relevance and coverage indicators. In addition and using system 211, a user has an option to override judgment input. For example, a user can override judgment input if the user disagrees with the judgment input. In addition, system 211., provides various features to provide the user with increased flexibility in analyzing and testing performance, using one or more performance indicators (and corresponding one or more metrics), even in a case that a complete set of judgment input is unavailable. In accordance with one or more embodiments, system 211 allows the user to make “adhoc” tuning selections/decisions, to include “past performance tests” in an analysis, consider statistics concerning queries to be judged, and use absolute difference of scores, any two or more of which can be used in combination in accordance with one or more embodiments of the present disclosure.

In accordance with one or more embodiments, “adhoc” tuning selections/decisions can comprises making decisions regarding relevance of results items for which judgment input is unavailable. For example, the user can indicate whether or not result items which have no associated judgment input are to be treated as relevant or nonrelevant result items. Alternatively, the user can indicate that precision/relevance is to be determined based on those result items which have associated judgment input, thereby excluding the result items for which judgment input is unavailable. As yet another option, which can be used, with one or more other “adhoc” tuning selections/decisions, the user can elect to use a rank-based approach for determining precision/relevance.

System 211 further provides flexibility to use indicators/metrics corresponding to one or more other performance tests, in accordance with at least one embodiment. For example, the user can elect to perform one or more other precision determinations based on a precision determinations made in other performance tests. In accordance with at least one embodiment, queries, and their corresponding result sets, can be grouped based on the associated footrule and overlap metric values, i.e., the queries can be grouped based on whether or not a query returned the same results in the same order (footrule(0) and overlap(1)).

The queries can be separated into the queries with a footrule value of zero, i.e., those queries which had no change in their result sets from one crawl to the next, and those queries with a footrule value greater than zero, i.e., those queries that have differing results sets from one crawl to the next. The first category, or group, of queries (i.e., the group of queries whose footrule value is zero) is represented as N, and the second group of queries (i.e., the group of queries whose footrule value is other than zero) is represented as M. In addition, Z percent represents the precision calculation at a given position, or rank, in the result sets. The group, N, of queries whose footrule value is zero can be further divided into queries with complete judgment input, N1 and those queries with partial judgment input, N2, with the precision value for the N1 queries being X percent. For the remaining N2 queries with partial judgment input, the Z percent (which represents a precision calculation for a given position, or rank) is used. The assumption is that the queries which return the same result for both crawls might still have the same precision. The combined precision value, X′ for both subgroup's of N, i.e., N1 and N2 can be determined as follows:

X′=(N1* X1%)+(N2* Z%/(N1+N2) (25)

Turning to the group, M, of queries whose footrule value is other than zero, can be further divided into queries whose result set has complete judgment input, M1, and the group of queries whose result set has partial judgment input, M2. Let Y1 percent represent the precision calculation for the M1 group of queries. For the remaining M2 group of queries with partial judgment input, the precision can be extrapolated using the precision for complete judgment input at a given position or rank, or Z percent, as discussed above. The precision value, Y2, can be determined as follows:

Y2=((M1* Y1%)+(M2* Z%))/(M1+N)) (26)

The precision for the queries with different set of results can be determine as follows:

Y′=(M1* Y1%)+(M2*Y2%)/(M1+M2) (27)

The cumulative precision at a position can be determined as follows:

((N/M+N)*X′)+((M/M+N)*Y′) (28)

The cumulative precision at all positions is calculated similarly.

Precision can be computed over a differential set of queries. This analysis can be useful in a case that the data in providers/source 205 continuously changes, or changes at a greater frequency than other data sources. The new data might hold the same relevance as the previous data. This analysis can use a precision determination from judgment data associated with the result that is the same for both crawls. Precision, Pi can be calculated for a given position, i, in a result set, as follows:

Pi=(Number of relevant results up to position “i”+change in the precision for the two crawls)/Number of results up to position i

The change in precision at a position could be: −1, the result in a result set in the first crawl is relevant and the result at the same position in the same result set in second crawl is irrelevant; 0, both the result at the same position in both of the first and second crawls have the same relevance, e.g., both are either relevant or irrelevant; or 1, the result in the first crawl is irrelevant and the result at the same position in the second crawl is relevant.

The change can be combined with a precision metric score determined for results up to the ith position in the ranking, or ordering, of the results. Thus, a total change shows either an improvement in performance (e.g., such as in a case that performance associated with the later crawl using a modified search engine 204 is considered to be improved over performance associated with a previous crawl using the same search engine 204 without the changes). For the remaining set of queries which haven't changed, the previously-determined precision at that position is assumed. For this analysis, it is possible to only analyze those results which differ at a particular position out of all the queries which have footrule>0 (queries with different results). It is a quick and simple method to analyze the changes in the results.

In accordance with embodiments of the present disclosure, system 211 allows the user to determine, for a given performance test, for example, the queries for which judgment input has not been received, and/or the number of results per query for which judgment input has not been received, and overlap and footrule distance measures. Embodiments provide the user with an option to estimate the remaining judgments. For example, the user has an option to generate one or more estimates for: all of the queries for which judgment input is not available, the queries with a footrule>0 (e.g., those queries that differ in their results or in the order of the results) and/or queries with partial judgment input, and/or queries with non-matching results at a position for which there is no judgment input.

In accordance with embodiments of the present disclosure, system 211 can provide a histogram, which represents absolute difference of scores at each position, such as the absolute gain and loss (e.g., precision gain or loss) at each position over the entire set of queries, which can represent performance from one crawl to the next. The number of pairs that were compared to generate the absolute number can also be provided with the histogram, in order to facilitate analysis of the histogram.

In accordance with one or more embodiments, an estimate can be provided before a performance test commences using system 211. For example, judgment input with a consistent scale for a series of performance test can be aggregated using a relevance scale corresponding to the previous performance tests. The judgment input with a consistent scale for a series of performance tests can be aggregated using a relevance scale. These judgments can be used to estimate a precision for the current performance test using the same scale as of the aggregated judgments. The current performance test needs to be setup or at least the crawl for the providers needs to be complete in order to configure the pre-performance test analysis. The information used to specify the crawls for the new performance test can then be used perform the pre-performance test. In accordance with at least one embodiment, one or more precision curves can be displayed at each grade on the relevance scale for every position. Two kinds of precision curves can be generated, for example, precision for all the result items having no judgment input, and the other for result items which have judgment input.

Performance test definition and evaluation system 211 enables a user to analyze various aspects of search results, including variations in search results, in relevance of results or in the coverage. System 211 provides an ability to analyze a search engine's 204 performance, at one or more levels, e.g., at query/result level or an aggregate level. The following provides an example of output that can be provided by system 211, and possible interpretations of the output, in accordance with one or more embodiments of the present disclosure. It should be apparent that other types of output and interpretations are possible.

System 211 can provide an aggregate relevance (or precision) value to compare two crawls (e.g., which crawls can involve two instances of search engine 204), which relevance can be obtained from a relevance tab of a user interface provided by system 211, after selecting a given performance test. In addition, a simple average cumulative precision across all the queries and DCG can be provided at both a query level and an aggregate level. A simple average cumulative precision can be computed across all queries in a QB corresponding to a performance test, and a graph can be provided which illustrate both crawls. The curves shown in the graph can be low (e.g., assuming all results without judgments are irrelevant), and high (e.g., assuming all the results without judgments are relevant), an average precision (average of the low and high curves) and/or a predicted precision from the previously-conducted performance tests.

An actual precision can lie somewhere between the low and high curves. If the range of the two curves is close, then it can be assumed that a reasonable estimate of the precision can be made. In addition and if the range of the high and low curves is larger, confidence that an estimate reflects an actual precision is lower. Confidence can also be based on cache hit. A high cache hit ratio implies that a good prediction of the precision could be obtained and vice versa. Experimental validations have shown that at least a forty to fifty percent cache hit can be sufficient to determine whether one configuration of a search engine 204 is performing better or worse than another search engine 204 configuration, for example.

An average precision curve can use the average of the low and high curves using an assumption of a 50% probability. The rank-based predicted precision curve generates a precision curve based on precision results of previous performance tests. One assumption is that a subsequent search engine 204 configuration may not have a worse configuration than a previous search engine 204 configuration. In such a case, an average of precision results from one or more previous performance tests for the previous search engine 204 configuration can be used to compute precision results for the subsequent search engine 204 configuration, which can be a function of the low and high precision curves. The following illustrates one example of a rank-level precision calculation, which can be used in connection with one or more embodiments, where i represents a relevance rank in a result set:

Rank predicted precision (i)=low precision(i)+((high precision(i)−low precision(i))*prior average precision for one or more previous tests(i))

The prior precision values can be obtained from analysis database 210, for example. Judgement database 206 can include minimum, maximum, average and recent precision scores for one or more previous performance tests. In accordance with one or more embodiments, the user can specify the previous performance tests to use to estimate precision, or a default specification (e.g., all performance tests for a given search engine 204 configuration) can be used to build a predictive model.

In accordance with one or more embodiments, a DCG can be computed, and one or more graphs can be displayed to show, for both crawls in a performance test, a low and high DCG curve, i.e., corresponding to assumptions that all unknown judgments either irrelevant and relevant, respectively. The DCG can also be computed on the query level.

A distance metric (e.g., one or all of Footrule, Kendall Tau, and overlap metrics) can be used, in accordance with one or more embodiments, to provide a measure of the extent of overlap in the results between the two crawls. Footrule, Kendall and overlap metrics are computed.

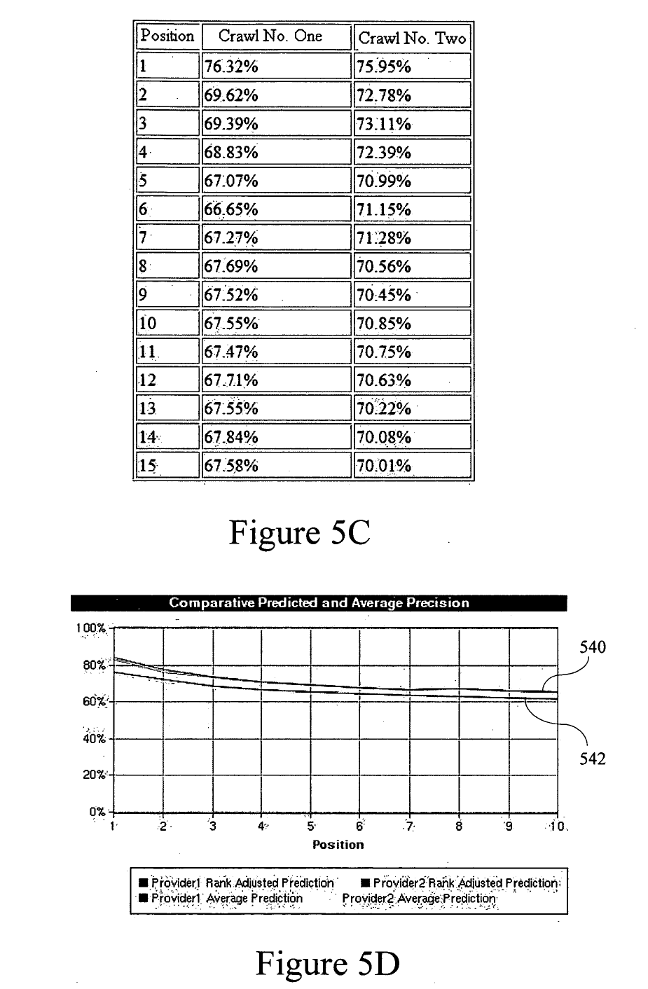

On an aggregate level, cumulative match and pie chart graphs can be output showing a footrule distribution. FIGS. 5A and 5B illustrate pie chart and cumulative match graphs for use with one or more embodiments of the present disclosure. Referring to FIG. 5A, a pie chart is illustrated which shows a percentage of the queries with a distance change breakdown, which shows a distribution of the distance change. The distance change is given in the range of zero to one, with 0 indicating that the results of the two crawls (e.g., and the two configuration of search engine 204) being compared are the same, and 1, at the other end of the spectrum, indicating that the results of the two crawls are very different or the results are the same but are ranked in a different or reverse order. For example, section 501 of the pie chart corresponds to a zero change between the two crawls, and indicates that fifty percent of the result sets were unchanged between the crawls.

The cumulative match chart can be used to show a number of results that overlap up to a ranking or position. The cumulative match chart can be used to evaluate a percentage of results that overlap in the two result sets corresponding to the two crawls. In accordance with one or more embodiments, the cumulative match data is cumulative across each rank, or position, and is aggregated over all the queries in the performance test. A high cumulative match percentage for a given position indicates that the results in the crawls are predominantly the same up to that position. FIG. 5B provides an example of a cumulative match chart, which shows a percentage of overlap by position, or rank.

On the query level, the footrule and kendall metrics for each query can indicate a difference in the results themselves and/or in the ordering of the results. A high value of footrule or kendall indicates the results in the two crawls are ranked differently and/or each engine returned a different set of results. A footrule or kendall value of zero can indicate that the results of the two crawls returned the same result set. A user's examination can thereby be focused on the one or more queries that have an associated high footrule and/or kendall metric value, in order to identify the differences in the results, and/or to gain an understanding of the reasons for the differences. An overlap measure can be used to indicate the distribution of results in the two crawls without taking into account the ranking of the result. A range can be between zero and one, with 0 indicating those queries that have no overlap in results sets between the two crawls, and 1, and the other end of the spectrum, indicating a 100% overlap in the results between the two crawls. Embodiments of the present disclosure can sort the queries in accordance with their overlap metric value, so that the user can identify the queries for which the results sets are different, in order to examine them more closely (e.g., to identify the differences and or the reasons for the differences).

In accordance with at least one disclosed embodiment, coverage metrics can be provided on a query level and/or at an aggregate level. On an aggregate level, a number of results returned per query can be aggregated across an entire result set. The aggregate number can be used to determine which of the two crawls has the higher coverage, for example. The absolute number aggregated across an entire result set can be determined for each result position (i.e., a number one ranked result, number two ranked, etc.) and each crawl, and the aggregate number for each position and each crawl can be displayed in a histogram, with the two numbers corresponding to the two crawls for a given position being represented side-by-side in the histogram. The user can then review the histogram to evaluate coverage issues by result position, for example.

A cache hit can be provided, in accordance with one or more embodiments, which cache hit can be represented as a percent of the number of judgments found for the queries. A high cache hit suggests that the performance test provides a good prediction or estimate of performance, for example. On a query level, a cache hit can be reported as a number of results, the number of hits and a percentage of judgment input available per query. The number of results reported on the query level can be used, for example, to identify queries that are returning a different number of results in the two crawls.

FIG. 5C provides an example of an aggregate precision metric, which identifies a percent of result items at a given relevance rank found to be relevant. In other words and with respect to the first crawl, 76.32% of the judgment input indicated that a result item ranked the most relevant in a query result set was relevant. The value is aggregated across all of the queries in the first crawl. In contrast, 75.95% of the judgment input corresponding to the second crawl indicated that the number one ranked relevant result item for the queries in the second crawl was relevant.

The following provides an example of a process that can be used to analyze a performance test and its corresponding results in accordance with one or more embodiments. The example assumes that a reasonable number of judgments are available.

An initial check of the cache hit percentage can be made to determine a degree of coverage. If there is an acceptable degree of coverage for each of the two crawls, an average precision curve can be examined as well as a predicted precision curve, which is based on previously-conducted performance tests. An average precision curve shows a high curve, which corresponds to an assumption that missing judgments are irrelevant, and a low curve, which corresponds to an assumption that missing judgments are relevant. FIG. 5D provides an example of average precision curves 542 for the two crawls and of rank-based prediction curves 540 in accordance with one or more embodiments. As discussed herein, a minimal difference between the curves suggests that a reasonable estimate of the precision can be made. A predicted precision can be, for example a rank-based prediction. The precision curves for the two crawls can be compared to evaluate which one, if any, of the crawls indicates a better performance.

Aggregate distance metrics can be examined to determine whether or not the two crawls have a high percentage of overlap, which can suggest minimal change in the results. If there is not a high percentage of overlap, it can be assumed that there is a performance issue. In such a case, the queries that have a high degree of variance between the two crawls can be examined in order to determine which crawl has a better associated performance. With regard to the queries that have a high variance, system 211 can compute an adhoc relevance that have associated judgment input, as one indicator of performance of the two crawls.

In a case that there is insufficient judgment input for a performance test, a distance between the two crawls can be estimated. If there is a high variance, its difficult to construct a strong proposition of relevance, but a small number of highly varying queries could be spot checked and judged and a quick estimate of the two crawls could be obtained. If the number of queries that vary between the two crawls is minimal, a spot check can be performed on the queries based on an overlap and/or on a footrule, and the queries can be randomly judged.

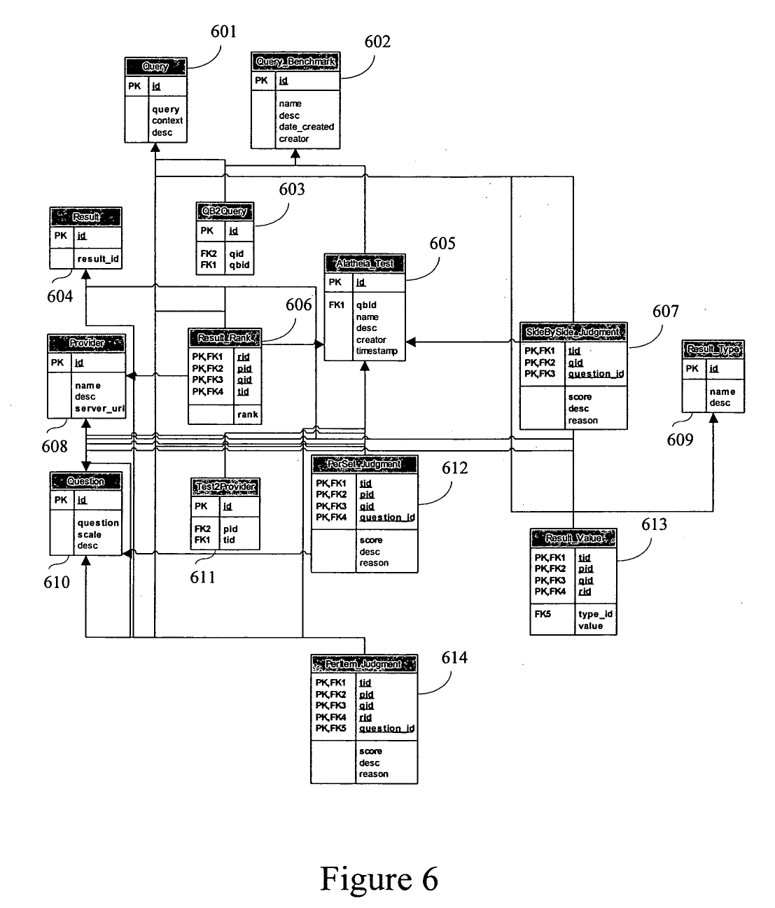

FIG. 6 provides an example of a database structure of analysis database 210 in accordance with one or more embodiments of the present disclosure. In one or more embodiments, analysis database 210 includes tables 601 to 614, which contain information corresponding to queries, query results, judgment input, QBs, performance test, etc. Query 601, for example, contains information concerning each of the queries. A “QB2Query” table can be used to associate multiple queries to a QB, and table 602. In the example shown, a QB can include multiple queries, and a query can be included in multiple QBs. Table 605 corresponds to a performance test instance, and includes a relational reference, “qbid”, to the QB table 602. The provider table 608 corresponds to crawl instances, and table 611 associates a crawl to a performance test. Table 606 provides a rank for a result and associates the ranked result (table 604) to a crawl (table 608), query (table 601) and test (table 605).

A result stored in result table 604 is associated with a result value stored in table 613. Tables 607, 612 and 614 store “side-by-side”, “per set”, “per item” judgment input, respectively, for results stored in result table. In addition, table 610 stores one or more questions associated with judgment input, e.g., a question used by judgment system 207 to prompt a judge 208 to enter the judgment input.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of-the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

We claim:

1. An information retrieval engine evaluation method, comprising:
identifying a query benchmark comprising a plurality of queries, the queries having corresponding search results;
obtaining judgment input from one or more judges, the judgment input corresponding to the set of search results;
determining, using the judgment input obtained from the one or more judges, at least one metric corresponding to an indicator of performance, a first value of the at least one metric corresponding to a first information retrieval engine and a second value of the at least one metric corresponding to a second information retrieval engine; and
comparing the first and second values of the at least one metric to evaluate the performance indicator so as to evaluate performance of the first information retrieval engine relative to the second information retrieval engine based on the query benchmark.

2. The method of claim 1, wherein the first and information retrieval engines comprise search engine instances and the performance indicator comprises an indicator of relevance of search results generated by the search engine instances.

3. The method of claim 1, further comprising
determining at least one other metric corresponding to at least one other indicator of performance, a first value of the at least one other metric corresponding to the first information retrieval engine and a second value of the at least one other metric corresponding to the second information retrieval engine; and
comparing the first and second values of the at least one other metric to evaluate the at least one other performance indicator so as to evaluate performance of the first information retrieval engine relative to the second information retrieval engine.

4. The method of claim 3, wherein the first and second information retrieval engines comprise search engine instances and the at least one other performance indicator comprises an indicator of differences between search results generated by the search engine instances.

5. The method of claim 3, wherein the first and second information retrieval engine comprise search engine instances and the at least one other performance indicator comprises an indicator of coverage of search results generated by the search engine instances.

6. The method of claim 1, wherein the first and second information retrieval engines comprise different configurations of a search engine.

7. The method of claim 1, wherein the first and second information retrieval engine comprise different search engines.

8. The method of claim 1, further comprising:
examining the judgment input to identify inconsistencies in the judgment input.

9. The method of claim 8, wherein examining the judgment input further comprises:
examining the judgment input to identify an inconsistency in a given judge's judgment input.

10. The method of claim 8, wherein examining the judgment input further comprises:
examining the judgment input to identify an inconsistency in one judge's judgment input relative to at least one other judge's judgment input.

11. A method of measuring search engine performance using a set of stored queries, results and judgments, the method comprising:
generating a query benchmark from the set of stored queries, the query benchmark includes one or more queries;
obtaining query results using the one or more benchmark queries;
retrieving one or more stored results associated with the plurality of queries;
retrieving a judgment associated with at least one stored result;
predicting a judgment associated with one or more of the obtained results based on the at least one stored result; and
determining a performance measure using the retrieved and predicted judgments.

12. The method of claim 11, wherein a judgment associated with a stored result identifies relevancy of the stored result to the query.

13. The method of claim 11, further comprising:
storing each of the plurality of queries in a query log;
for each query stored in the query log:
performing the query to obtain a set of results, the set of results including at least one result item; and
obtaining a judgment corresponding to the at least one result item.

14. The method of claim 13, further comprising:
examining an obtained judgment to determine whether an inconsistency exists in the obtained judgment.

15. The method of claim 14, wherein a judgment is based on user input, and wherein examining an obtained judgment to determine whether an inconsistency exists in the obtained judgment further comprises:
comparing a user's judgment input associated with a result item to predetermined judgment input for the associated result item.

16. An information retrieval engine evaluation system, comprising:
program memory for storing process steps executable to: identify a query benchmark comprising a plurality of queries, the queries having corresponding search results, obtain judgment input from one or more judges, the judgment input corresponding to the set of search results determine, using the judgment input obtained from the one or more judges, at least one metric corresponding to an indicator of performance, a first value of the at least one metric corresponding to a first information retrieval engine and a second value of the at least one metric corresponding to a second information retrieval engine; and compare the first and second values of the at least one metric to evaluate the performance indicator so as to evaluate performance of the first information retrieval engine relative to the second information retrieval engine; and
at least one processor for executing the process steps stored in said program memory.

17. A system for measuring search engine performance using a set of stored queries, results and judgments, the system comprising:
program memory for storing process steps executable to: generate a query benchmark from the set of stored queries, the query benchmark includes one or more queries; obtain query results using the one or more benchmark queries; retrieve one or more stored results associated with the plurality of queries; retrieve a judgment associated with at least one stored result; predict a judgment associated with one or more of the obtained results based on the at least one stored result; and determine a performance measure using the retrieved and predicted judgments; and
at least one processor for executing the process steps stored in said program memory.
